(19) United States
(12) Patent Application Publication
(10) Pub. No.: US 2005/0035650 A1
(43) Pub. Date: Feb. 17, 2005

(54) Track attachment for wheeled vehicle

(76) Inventor: Heinrich Toews, Manitoba (CA)

Correspondence Address: Ryan W Dupuis;Ade & Company, 1700-360 Main Street, Winnipeg Manitoba, R3C 3Z3, CA

(21) Appl. No.: 10/497,920

(22) PCT Filed: Dec. 5, 2002
(86) PCT No.: PCT/CA02/01867

(30) Foreign Application Priority Data
Dec. 6, 2001 (US) 60336158

(51) Int. Cl. B60B 37/00

(52) U.S. Cl. 301/1

(57) ABSTRACT

A track attachment for a vehicle includes a pair of idler wheels rotatably supported by a beam on opposing sides of a main drive wheel of the vehicle. The beam is mounted on the axle housing of the main drive wheel. An endless track is supported about the idler wheels and the main drive wheel to follow the common drive path thereof. Supporting the track attachment on a respective axle housing of the vehicle ensures that weight of the vehicle is supported in a stable manner on the endless track while the components of the device are protected on an inner side of the wheel upon which the track attachment is supported.

### FIELD OF THE INVENTION

The present invention relates to a track attachment for conversion of a conventional wheel assembly of a vehicle to a tracked wheel configuration.

### BACKGROUND

Tracked vehicles are known in various forms, typically in instances in which additional traction is desired as compared to conventional single or dual wheel assemblies or in instances in which weight of the vehicle is desired to be distributed over a larger area. Known tracked vehicles however are generally very large and costly and often not practical for small scale applications.

U.S. Pat. No. 5,388,656 to Lagasse provides a traction device for securement to the wheel of a vehicle which includes a pair of idler wheels supported on opposing sides of the wheel of the vehicle and an endless track supported about the wheels. The device requires attachment to an outer side of the wheel which places considerable stress on the outer end of the axle and results in an awkward vehicle configuration including frame members projecting laterally outwardly beyond the wheels thereof. Furthermore, the traction device is readily susceptible to damage as a result of being supported on an outer side of the wheel of the vehicle.

### SUMMARY

According to the present invention there is provided a track attachment for a vehicle supported on at least one axle by a respective axle housing rotatably receiving the axle therein, said at least one axle being supported above the ground by respective wheel assemblies mounted thereon, the attachment comprising:
a rigid beam;
a pair of idler wheels rotatably supported at spaced apart locations on the rigid beam;
a beam mount arranged to support the rigid beam on the axle housing with the idler wheels positioned on opposing sides of one of the wheel assemblies so that the idler wheels and the wheel assembly follow a common drive path;
an endless track arranged to be supported about the idler wheels and the wheel assembly to follow the common travel path thereof; and
guide means for aligning the endless track with the idler wheels and the wheel assembly.

The use of a track attachment mounted on a respective axle housing of the vehicle ensures that weight of the vehicle is supported in a stable manner on the endless track while the components of the device can be protected on an inner side of the wheel upon which the track attachment is supported.

The beam mount is preferably arranged to support the beam on the axle housing of the vehicle between the wheel assembly and the vehicle on an inner side of the wheel assembly.

The beam may be pivotally supported in relation to the beam mount, the beam mount being fixedly mounted on the axle housing.

The beam may be pivotal about a swivel axis lying parallel and spaced below an axis of the wheel assembly. Alternatively, the beam may be pivotal about the axle housing of the vehicle.

The idler wheels are preferably supported for height adjustment relative to the beam mount. The idler wheels are preferably also supported for adjustable relative spacing therebetween independent of height adjustment.

When the beam comprises a hollow tube supporting a post within each end thereof and each post supports one idler wheel thereon, shims may be supported between the post and an interior of the beam to adjustably position the post relative to the beam. The shims preferably comprise a pair of opposed wedges between each post and the interior of the beam.

In the preferred arrangement, both idler wheels are supported for adjustment in a longitudinal direction of the beam relative to the beam.

When there is provided a wheel assembly comprising a drive wheel supported on a drive axle of the vehicle, the track preferably includes positive drive means to couple the track to rotate together with the drive wheel.

When there is provided a wheel assembly comprising a pair of dual drive wheels, the attachment preferably includes a drive member supported for rotation with the dual drive wheels which meshes with lugs supported on an inner surface of the track. The drive member and the lugs on the track may be supported for alignment with a gap between the dual drive wheels of the wheel assembly.

When used on a vehicle in which the wheel assembly comprises a dual wheel set, the guide means preferably comprises a plurality of guide members mounted on an inner side of the track for alignment with a gap between wheels of the dual wheel set.

In the preferred embodiment, the track is formed of recycled tire portions. This may be accomplished by dividing a tire into two tread portions about a circumference of the tire and reassembling the two tread portions with respective side wall portions of the two tread portions being secured adjacent one another in a confronting manner. The side wall portions thus preferably define the guide means. Additional reinforcement members may be secured between the side wall portions of the two tread portions for use in a positive drive configuration.

The beam mount may be selectively coupled to the axle housing using suitable fasteners so as to permit the beam and idler wheels supported thereon to be readily disconnected from the axle housing as desired.

When used in combination with a tractor having four drive wheels, one track attachment is preferably supported on the axle housing adjacent each respective drive wheel.

There may be provided an offset bracket supporting each drive wheel at a position offset from the respective axle to increase a wheelbase and a ride height of the tractor. The offset bracket permits ride height to remain constant even when smaller wheels are used. In this instance each offset bracket would include a transfer case for transferring drive to the respective drive wheel from the respective axle. The transfer case may include gear reduction for permitting use of smaller wheels on the track attachment or for improving performance characteristics as desired.

The track attachment may be used in combination with a highway tractor conversion kit including a transfer case for transferring drive to all wheels of the highway tractor in which one track attachment is supported on each wheel.

### BRIEF DESCRIPTION OF THE DRAWINGS

In the accompanying drawings, which illustrate an exemplary embodiment of the present invention:

FIG. 1 is a schematic side elevational view of the track attachment.

FIG. 2 is a front view of the track attachment according to FIG. 1 with the track shown partially removed.

FIG. 3 is a side elevational view of the track attachment with an outer wheel of a dual wheel set shown removed.

FIG. 4 is a top plan view of the beam supporting the idler wheels thereon according to the track attachment of FIG. 3.

FIG. 5 is a sectional view along the line 5-5 of FIG. 4.

FIG. 6 is a side elevational view of a modified highway tractor having a track attachment supported on each wheel assembly thereof.

FIG. 7 is a bottom plan view of the tractor according to FIG. 6.

FIG. 8 is a side elevational view of the transmission and transfer case illustrated in FIG. 7.

### DETAILED DESCRIPTION

Referring to the accompanying drawings, there is illustrated a track attachment generally indicated by reference numeral 10. The attachment is particularly useful for a wheeled vehicle 12 to convert a conventional wheel assembly 14 into a tracked configuration.

The attachment 10 may be used on conventional highway tractor trucks as illustrated in FIG. 6 to modify the vehicle for different applications. In further embodiments, the track attachment may be used to replace the drive wheel 16 of a tractor as illustrated in FIG. 1. Also, when no positive drive is provided to the track attachment, the track attachment may be useful for assisting floatation of grain carts or grain and bale wagons and the like for use on soft terrain.

In general, the track attachment 10 is used on a vehicle which is supported on at least one axle 17 which is rotatably received within a fixed axle housing 18 on the frame of the vehicle. The axle 17 is accordingly supported above the ground on respective conventional wheel assemblies 14.

The track attachment 10 generally includes two idler wheels 20 which are carried on a rigid beam 22 and spaced positions therealong for locating the idler wheels 20 on opposing side of a main drive wheel 24 in the longitudinal direction of travel of the wheel assembly. The beam 22 is mounted by a suitable hanger 26 which is fixedly mounted onto the axle housing 18 on the frame of the vehicle.

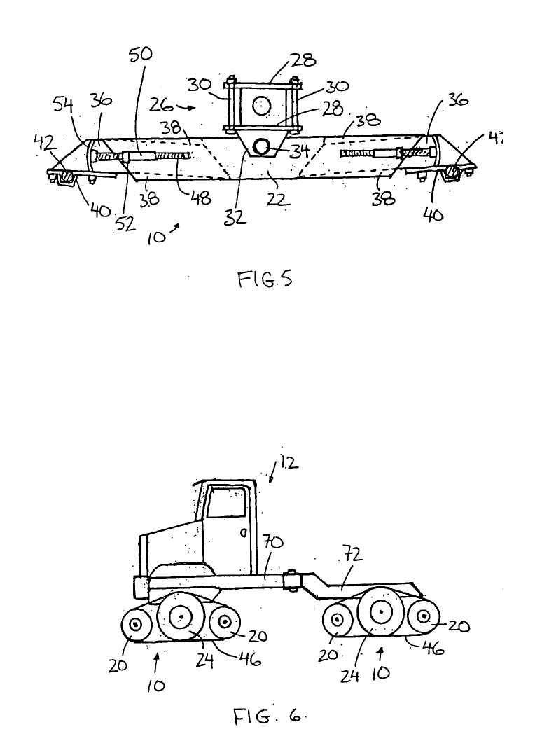

As illustrated in further details in FIGS. 4 and 5, the hanger 26 is arranged to be clamped over the axle housing by providing top and bottom and hanger plates 28 which are bolted on opposing sides of the axle housing by respective bolts 30 extending between the plates on opposing sides of the housing in a clamping configuration. A pair of parallel and spaced apart swivel plates 32 are fixed to the bottom hanger plate at positions which are spaced in the axial direction of the wheel axle.

The swivel plates 32 pivotally receive a swivel pin 34 extending therethrough to lie parallel and spaced below the axle of the vehicle. The swivel pin 34 extends through the beam 22 at a central location in the longitudinal direction of the beam to position the beam for pivotal movement about an axis of the swivel pin between the swivel plates 32. The beam accordingly extends in the direction of travel so as to lie in a plane which is perpendicular to the axle of the vehicle. The idler wheels 20 are carried on opposing longitudinal ends of the beam as noted above.

The beam generally comprises a hollow tube of rectangular cross section. The open ends of the tube are cut at a downward and inward slant and permit respective posts 36 to slidably received therein. Each post 36 carries a respective idler wheel 20 thereon to permit some adjustment of the idler wheel relative to the beam. The cross section of the post is suitably arranged to snugly fit laterally within the hollow cross section of the beam but is considerably narrower in height than the interior dimensions of the beam to permit some vertical adjustment of the idler wheels relative to the beams.

Shims 38 are provided for fitting between the post and the interior dimensions of the beam for proper securement in use. The shims generally comprise a pair of opposed wedges supported within each end of the beam for cooperation with a respective post received therein. When the opposed wedges are positioned in an overlapping configuration, a generally rectangular plate is formed which may be positioned either above or below the post carrying idler wheel to permit some limited raising and lowering of the idler wheel relative to the beam depending upon location of the shims.

Alternatively when positioning one wedge above the post 36 and the corresponding wedge below the post, the post may be inclined upwardly or downwardly in an outward direction in relation to the longitudinal direction of the beam to further permit some height adjustment of the free ends of the posts 36 carrying the idler wheels 20 thereon relative to the beams.

A bracket 40 is supported on the free end of each post 36 for coupling the respective idler wheel 20 thereon. The bracket generally comprises a channel formed in a plate which receives the respective idler axle 42 therein so that the idler axle 42 projects laterally outwardly from the post and beam to carry the idler wheels in alignment with the main drive wheel 24 when the beam is supported on an inner side of the wheel assembly. The channel formed in the bracket 40 is offset to one side of the bracket while the bracket is configured for mounting so as to be reversible in the longitudinal direction of the beam and in the direction of travel of the vehicle to permit position of the channel supporting the idler axle and accordingly the idler axle itself to be located at various longitudinal positions relative to the beam. The idler wheel itself is supported on a rotatable hub 44 fixed at the free end of the respective idler axle 42.

An endless track 46 is supported about the periphery of the idler wheels and the main drive wheels under tension so as to cause the posts 36 carrying the idler wheels thereon to be urged inwardly into a retracted position within the beam. A tension mechanism is provided on the beam which urges the posts 36 outwardly from the beam in the longitudinal direction.

The tension mechanism generally comprises a threaded rod 48 extending through a tube 50 supported on the beam on an outer side thereof, the position of which is determined by a suitable nut 52 threaded onto the rod for engagement with the end of the tube 50. The free end of the rod is thus adjustable in spacing from the beam by adjusting the nut 52. A curved plate 54 is fixed onto the side of the post in alignment with the rod 48 for abutting the free end thereof to accordingly restrict inward movement of the post relative to the beam.

The plate 54 includes a concave inner surface which confronts the free end of the rod to ensure that the plate adequately engages the rod regardless of the vertical position or inclination of the post 36 relative the beam. Adjusting the nut 52 permits the free end of the rod to be displaced outwardly to accordingly urge the plate and post 36 upon which it is fixedly mounted outwardly to apply tension to the track.

The main drive wheel 24 comprises a dual set of wheels which are spaced apart in an axial direction sufficiently to receive a positive drive plate 60 therebetween. The drive plate 60 is a circular plate having gear teeth about a periphery thereof which are suitably arranged for meshing engagement with lugs 62 about a periphery of an inner surface of the track 46. The lugs 62 on the track are positioned to be aligned with the gap between the dual wheels of the main drive wheel set. The drive plate 60 is supported for fixed rotation relative to the rims and drive axle of the main drive wheels.

In this configuration the idler wheels 20 each comprise a dual set of wheels as well having a gap therebetween in alignment with the lugs 62 on the inner surface of the track. The lugs 62 accordingly form a guide which centers the track on the dual idler wheels and dual main drive wheels. Positioning guide members between a dual wheel set ensures that the guides are hidden and well protected.

The track 46 is formed from large tractor tires which are recycled to form an endless track. The tractor tires are split in half in the axial direction to define two annular members which are repositioned with the side wall portions 64 confronting one another directly adjacent one another. The side wall portions 64 are trimmed to match the profile of the lugs 62 and are joined by suitable fasteners and cementing to form an endless track with integral guide members to be positioned between a dual wheel set. The lugs 62 themselves may be used as fasteners for securing the recycled tire portions together and act as a reinforcement secured between the side wall portions of the tires. In alternate configurations, two tires may be used to form a single track of considerable width as compared to the illustrated embodiment. The two tires would be fastened at respective side wall portions as described above with regard to the illustrated embodiment.

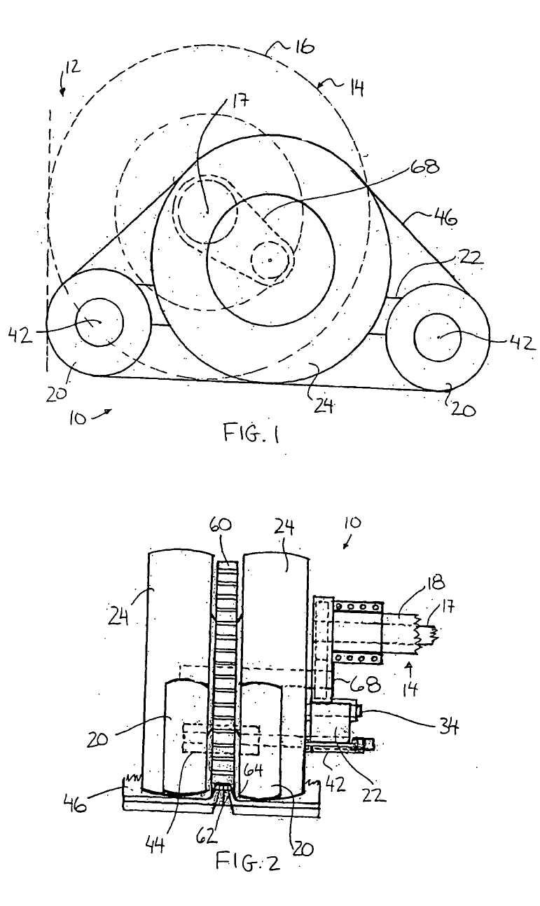

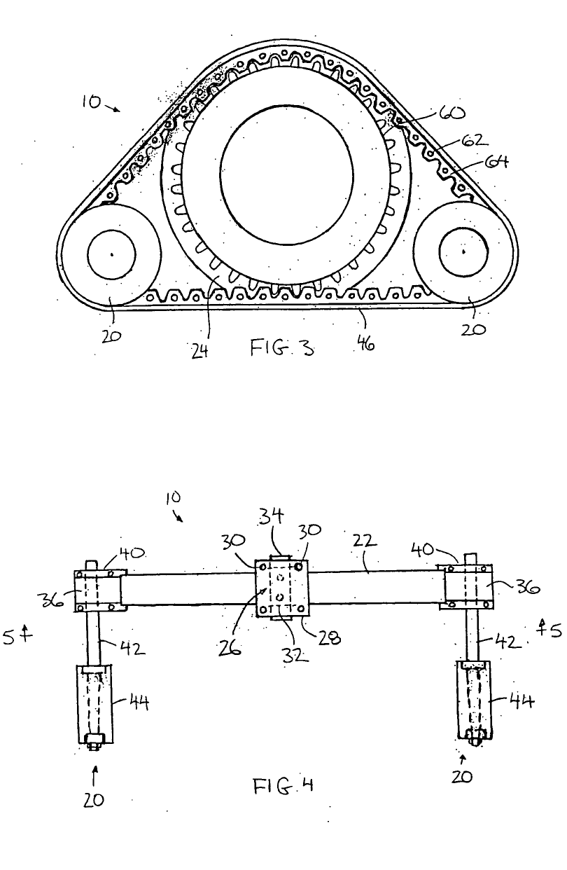

As illustrated in FIGS. 1 and 2, when all four wheels of an all wheel drive tractor are to be converted using the track attachment 10, it is preferable to increase the wheel base of the tractor for improved steering by offsetting the main drive wheel of the attachment outwardly in a longitudinal direction of travel of the vehicle from the respective drive axle 17 of the vehicle. A bracket 68 is accordingly provided which pivotally suspends the swivel pin 34 of the beam therefrom similarly to the hanger 26 previously described. The bracket 68 also supports the swivel pin downward in relation to the axle 17 and axle housing to permit smaller tires to be used while maintaining ride height substantially equal or greater to that of the larger conventional tires 16 being replaced.

The swivel pin in this arrangement is supported parallel and offset outwardly in the longitudinal direction of the vehicle and downwardly from the drive axle of the tractor. The bracket 68 further carries a transfer case having suitable chain drive or geared drive coupled between the drive axle 17 of the tractor and the main drive wheel 24 axle. The transfer case includes suitable gear reduction to permit similar or improved performance characteristics of the tractor even when smaller tires are used in the track attachment than the conventional tires 16. The bracket 68 and the transfer case carried thereby are anchored in fixed relationship to the axle housing as previously described.

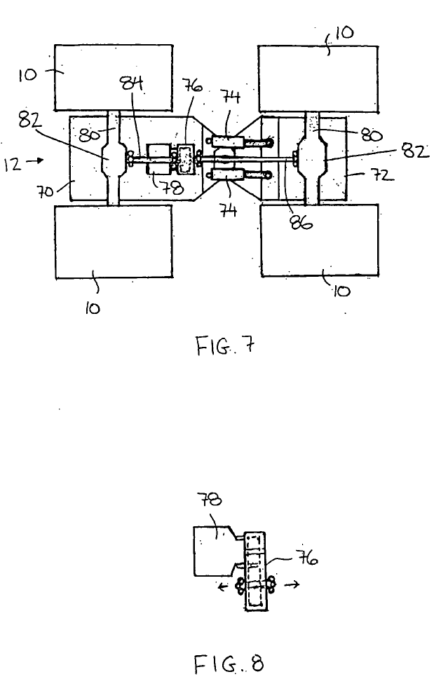

In one particular application illustrated in FIGS. 7 and 8, the track attachment 10 may be provided in combination with a kit for converting a highway tractor truck into an all wheel drive tracked vehicle. The kit includes a replacement base frame having a forward frame 70 and a rearward frame 72 which are articulated relative to one another about a centrally located vertical pivot. Pivotal movement between the forward and rearward frames is controlled by a pair of hydraulic piston cylinders 74.

A transfer case 76 is provided which couples to the existing transmission 78 of the truck to provide some gear reduction for slowing down the vehicle as well as to reposition the drive shafts of the truck. In the conventional arrangement two existing drive axles 80 are provided in a pair of rear wheel sets as driven by respective differentials 82 driven by a rear drive shaft. When installing the kit, the rearmost existing drive axle 80 is repositioned with the respective differential 82 to the front of the truck to be used as a front drive axle while the forwardmost rear existing drive axle 80 remains in position. A forward drive shaft 84 is coupled between the transfer case and the differential 82 of the repositioned front drive axle 80 while a rear drive shaft 86 couples between the transfer case and the differential of the rear drive axle 80 which remains in place. The track attachment 10 as described above is accordingly secured to the free ends of each drive axle 80 to provide for track attachments with all wheel drive as illustrated in FIG. 6.

As described above, a track attachment kit has been designed to provide powerful traction and floatation for farming and industrial applications of wheeled vehicles. A particular benefit is to reduce compaction and damage to farmland. Additional benefits to consumers include the use of a track attachment which is especially designed for overcoming wet field conditions. The attachment can save farm soil and grain crops from the negative effects of excessive compaction the configuration of the kit is useful on both new and existing equipment. Tracks may be provided in different sizes to accommodate varying tractors, power units and different tire sizes. Typically the track attachments on a vehicle would be powered by dual main drive wheels of the machine, and will operate effectively with a range of tractors and power units. The attachment Includes only two dual pneumatic tire idlers operating from one hub with two bearings which equates to a total of 16 bearings on a four-wheel drive.

The attachment 10 has minimal moving parts, so there is less to wear out or replace. As noted above with regard to compaction, the attachment helps with flotation of grain carts, grain and bale wagons, etc., especially on soft fields to protect fields from damage. Constant tension may be kept on the track via air and fluid cushion in the tires. Optionally, fluid in the tires provides added weight for traction where it is required, rather than extra steel weights hanging on the machine. The use of guide lugs on the inside of the track may be utilised for a positive drive system as noted above. Once installed, if the operator should choose to operate their vehicle the conventional way (without the track attachments), the attachments can be conveniently removed and re-installed at a later date.

The track attachment kit is a preferred arrangment comprises of a creeper attachment for tractors, combines, and swathers, operating off of the drive wheels. The track attachment kit also helps with flotation and is designed to lessen compaction of heavy farm machinery, including grain carts and grain and bale wagons in critically wet and soft field conditions as a non-power track.

The track attachment kit has a rubber track with grip treads on the outside and guide lugs on the inside. These have a choice of placement to accommodate a variation of tire sizes that may be encountered. On the unit the guide lugs between the dual drives and dual idlers serve as a mainstay direction guide for both power and flotation units.

The track attachment kit would have different track dimensions for different tire sizes for both power and flotation. The housing on the idler bracket that swivels on a sleeve on the axle housing would also involve variations for different axles.

The track attachment kit would offer a track made up of a twelve-ply steel belted endless rubber belt with treads vulcanized on the outside of belt and guide lugs vulcanized on the inside of belt.

The track attachment kit would offer an option of track made up of used large tractor tires or other suitable tires. The attraction would be a low price and the fact that these could offer extra pulling power for lower horsepower tractors already owned by farmers and industry. Different idler wheel sizes may be necessary to accommodate the consumers' tire sizes whenever possible.

While various embodiments of the present invention have been described in the foregoing, it is to be understood that other embodiments are possible within the scope of the invention. The invention is to be considered limited solely by the scope of the appended claims.

1. A track attachment for a vehicle supported on at least one axle by a respective axle housing rotatably receiving the axle therein, said at least one axle being supported above the ground by respective wheel assemblies mounted thereon, the attachment comprising:
a rigid beam;
a pair of idler wheels rotatably supported at spaced apart locations on the rigid beam;
a beam mount arranged to support the rigid beam on the axle housing with the idler wheels positioned on opposing sides of one of the wheel assemblies so that the idler wheels and the wheel assembly follow a common drive path;
an endless track arranged to be supported about the idler wheels and the wheel assembly to follow the common travel path thereof; and
guide means for aligning the endless track with the idler wheels and the wheel assembly.

2. The attachment according to claim 1 wherein the beam mount is arranged to support the beam on the axle housing of the vehicle between the wheel assembly and the vehicle on an inner side of the wheel assembly.

3. The attachment according to claim 1 wherein the beam is pivotally supported in relation to the beam mount, the beam mount being fixedly mounted on the axle housing.

4. The attachment according to claim 3 wherein the beam is pivotal about a swivel axis lying parallel and spaced below an axis of the wheel assembly.

5. The attachment according to claim 1 wherein the idler wheels are supported for height adjustment relative to the beam mount.

6. The attachment according to claim 5 wherein the idler wheels are supported for adjustable relative spacing independent of height adjustment.

7. The attachment according to claim 1 wherein the beam comprises a hollow tube supporting a post within each end thereof, each post supporting one idler wheel thereon, wherein there is provided shims supported between the post and an interior of the beam to adjustably position the post relative to the beam.

8. The attachment according to claim 7 wherein the shims comprise a pair of opposed wedges between each post and the interior of the beam.

9. The attachment according to claim 1 wherein both idler wheels are supported for adjustment in a longitudinal direction of the beam relative to the beam.

10. The attachment according to claim 1 for a wheel assembly comprising a drive wheel supported on a drive axle of the vehicle, the track including positive drive means to couple the track to rotate together with the drive wheel.

11. The attachment according to claim 10 for a wheel assembly comprising a pair of dual drive wheels, the attachment including a drive member supported for rotation with the dual drive wheels which meshes with lugs supported on an inner surface of the track.

12. The attachment according to claim 10 wherein the drive member and the lugs on the track are supported for alignment with a gap between the dual drive wheels of the wheel assembly.

13. The attachment according to claim 1 for a vehicle in which the wheel assembly comprises a dual wheel set wherein the guide means comprises a plurality of guide members mounted on an inner side of the track for alignment with a gap between wheels of the dual wheel set.

14. The attachment according to claim 1 wherein the track is formed of recycled tire portions.

15. The attachment according to claim 14 wherein the track is formed from a tire which has been divided into two tread portions about a circumference of the tire and reassembled with respective side wall portions of the two tread portions being secured adjacent one another in a confronting manner.

16. The attachment according to claim 14 wherein the side wall portions define the guide means.

17. The attachment according to claim 1 wherein the beam mount is selectively coupled to the axle housing using suitable fasteners so as to permit the beam and idler wheels supported thereon to be readily disconnected from the axle housing as desired.

18. The attachment according to claim 1 in combination with a tractor having four drive wheels, one track attachment being supported on the axle housing adjacent each respective drive wheel.

19. The attachment according to claim 18 wherein there is provided an offset bracket supporting each drive wheel at a position offset from the respective axle to increase a wheelbase of the tractor, each offset bracket including a transfer case for transferring drive to the respective drive wheel from the respective axle.

20. The attachment according to claim 1 in combination with a highway tractor conversion kit including a transfer case for transferring drive to all wheels of the highway tractor, one track attachment being supported on each wheel.
